(19) United States
(12) Patent Application Publication
(10) Pub. No.: US 2021/0039614 A1
(43) Pub. Date: Feb. 11, 2021

(54) BRAKE HYDRAULIC PRESSURE CONTROLLER

(71) Applicant: Robert Bosch GmbH, Stuttgart (DE)

(72) Inventors: Tsutomu Ninbari, Kanagawa (JP); Yoshio Tajika, Kanagawa (JP)

(21) Appl. No.: 16/965,642

(22) PCT Filed: Jan. 29, 2019
(86) PCT No.: PCT/IB2019/050701

§ 371 Date: Jul. 29, 2020

(30) Foreign Application Priority Data
Jan. 31, 2018 (JP) 2018-015425

(51) Int. Cl. B60T 8/17; B60T 13/66; F16M 13/02; F16F 15/08

(52) U.S. Cl. CPC B60T 8/17; B60T 13/66; F16F 2230/0005; F16F 15/08; F16F 2224/025; F16M 13/02

(57) ABSTRACT

[Problem] A brake hydraulic pressure controller in which a hydraulic unit is stably supported on a bracket and that can improve an effect of suppressing vibrations of the hydraulic unit is provided.

[Means for Resolution] In a brake hydraulic pressure controller (10) including: a hydraulic unit (20) that executes brake control by controlling a hydraulic pressure of a brake fluid; a bracket (80) that is attached to a vehicle body to support the hydraulic unit (20); and support members (110, 120) that are assembled in openings (80aa, 80ba) provided in the bracket (80) and coupled to the hydraulic unit (20), the support members (110, 120) are coupled to two mutually opposing surfaces (30a, 30b) of a housing (30) for the hydraulic unit (20).

### BACKGROUND OF THE INVENTION

The present invention relates to a brake hydraulic pressure controller.

A brake hydraulic pressure controller that executes brake control by controlling a hydraulic pressure of a brake fluid to be supplied to a braking section in a hydraulic circuit has been known. The brake hydraulic pressure controller includes a hydraulic unit. The hydraulic unit includes a freely openable/closable control valve, a pump element operated in cooperation with the control valve, a motor for driving the pump element, and the like.

The hydraulic unit also includes an electronic control unit (ECU). The control valve, the pump element, and the motor are operated under control by the ECU. When the hydraulic pressure in the brake hydraulic circuit is increased or decreased, a braking force generated in a wheel is controlled.

The brake hydraulic pressure controller is attached to a vehicle via a bracket. In the brake hydraulic pressure controller, the hydraulic unit is supported on the bracket by a support member that includes a vibration absorbing member arranged in an opening provided in the bracket (for example, see JP-A-2013-112054).

### SUMMARY OF THE INVENTION

In the conventional hydraulic unit, the motor is mounted on a surface of a housing, and the plural control valves and the ECU are attached to a surface that opposes this motor-mounted surface. In addition, the pump element is mounted on each of two opposing side surfaces of four side surfaces that continue perpendicularly from the motor-mounted surface and the ECU-attached surface. Furthermore, of the other two side surfaces, a coupling port, to which a fluid pipe is coupled, is provided in one side surface, and an accumulator is assembled to the other side surface.

It is difficult to set an attachment position of the support member, which supports the hydraulic unit on the bracket, on the surface formed with the coupling port and the ECU-attached surface. In addition, of the two opposing surfaces, to which the pump elements are mounted, electric wiring on the vehicle side coupled to a connector of the ECU is disposed on one surface side. Thus, it is difficult to set the attachment position of the support member on the surface side.

For this reason, the attachment position of the support member is selected from the motor-mounted surface, the accumulator-assembled surface, and the pump element-mounted surfaces, which are adjacent to each other. Conventionally, the hydraulic unit is supported on the bracket by using the two adjacent surfaces of the housing, and a positional relationship between a position of center of gravity of the hydraulic unit and an attachment position of the vibration absorbing member is likely to be unstable. Thus, there is a possibility that an effect of suppressing vibrations of the hydraulic unit is reduced.

The present invention has been made in view of the above problem and therefore has a purpose of providing a brake hydraulic pressure controller in which a hydraulic unit is stably supported on a bracket and which can improve an effect of suppressing vibrations of the hydraulic unit.

According to an aspect of the present invention, a brake hydraulic pressure controller is provided. In the brake hydraulic pressure controller including: a hydraulic unit that executes brake control by controlling a hydraulic pressure of a brake fluid; a bracket that is attached to a vehicle body to support the hydraulic unit; and support members that are assembled in openings provided in the bracket and coupled to the hydraulic unit, the support members are coupled to two mutually opposing surfaces of a housing for the hydraulic unit.

As it has been described so far, according to the present invention, the hydraulic unit is stably supported on the bracket, and an effect of suppressing vibrations of the hydraulic unit can be improved.

### BRIEF DESCRIPTION OF THE DRAWINGS

FIG. 1 is a perspective view of a brake hydraulic pressure controller according to an embodiment of the present invention.

FIG. 2 is a perspective view of a configuration example of the brake hydraulic pressure controller according to the embodiment.

FIG. 3 is a cross-sectional view of the configuration example of the brake hydraulic pressure controller according to the embodiment.

FIG. 4 is a cross-sectional view of a configuration example of a first support member according to the embodiment.

FIG. 5 is an explanatory view of external appearance of a second support member according to the embodiment.

FIG. 6 is a cross-sectional view of a configuration example of the second support member according to the embodiment.

FIG. 7 is an explanatory view of a position of center of gravity of the brake hydraulic pressure controller according to the embodiment.

FIG. 8 is an explanatory view of the position of the center of gravity of the brake hydraulic pressure controller according to the embodiment.

FIG. 9 is an explanatory view of the position of the center of gravity of the brake hydraulic pressure controller according to the embodiment.

### DETAILED DESCRIPTION

A detailed description will hereinafter be made on a preferred embodiment of the present invention with reference to the accompanying drawings. In the specification and the drawings, components that have substantially the same functional configurations will be denoted by the same reference signs, and a description thereon will not be repeated.

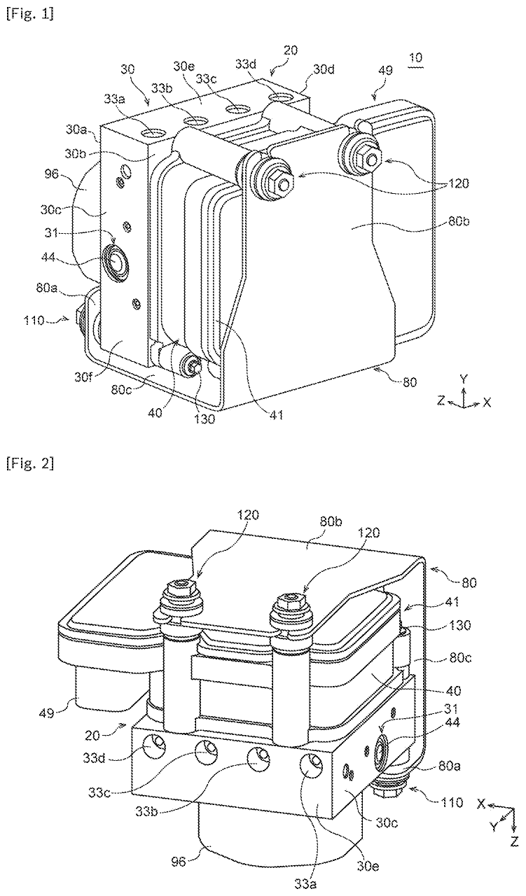

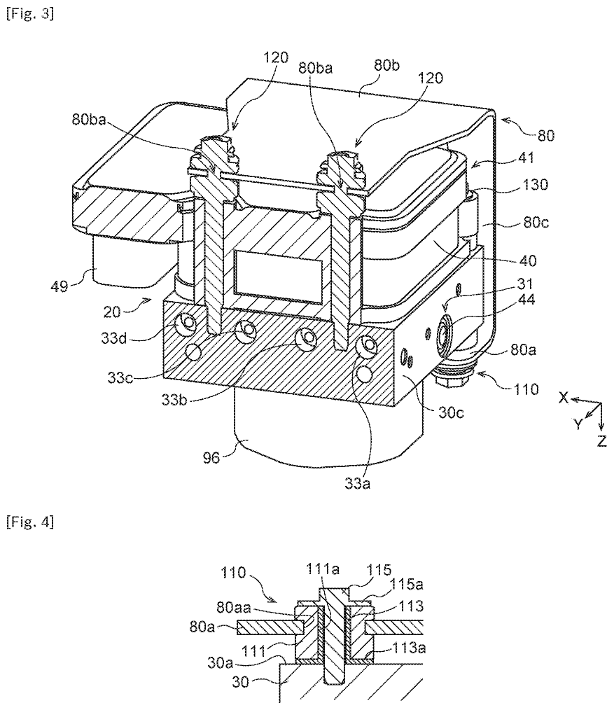

A description will be made on a configuration of a brake hydraulic pressure controller 10 according to this embodiment with reference to FIG. 1 to FIG. 3. FIG. 1 is a perspective view of the brake hydraulic pressure controller 10 that is seen from an ECU 40 side, and FIG. 2 is a perspective view of the brake hydraulic pressure controller 10 in FIG. 1 that is seen from an upper surface side. FIG. 3 is a perspective view of a cross section that includes axes of two second support members 120 in the brake hydraulic pressure controller 10 illustrated in FIG. 2.

The brake hydraulic pressure controller 10 according to this embodiment is a controller used for an electronic stability program (ESP) for a four-wheel vehicle, and has two systems of hydraulic circuits that respectively control braking forces of front wheels and rear wheels.

The brake hydraulic pressure controller 10 is not limited to that for the four-wheel vehicle but may be used for a brake system of another type of the vehicle such as a two-wheel vehicle.

The brake hydraulic pressure controller 10 includes a hydraulic unit 20 and a bracket 80. The hydraulic unit 20 includes a housing 30, a motor 96, a pump element 44, and the ECU 40. The housing 30 is a rectangular-parallelepiped member that is made of metal, for example.

The motor 96 is attached to one surface 30a of the housing 30. The motor 96 is attached to the housing 30 such that a motor shaft thereof is directed to the inside of the housing 30. The ECU 40 controls driving of the motor 96.

Plural control valves, each of which is not illustrated and controls a flow of a brake fluid in respective one of the two systems of the hydraulic circuits, are mounted on a surface 30b. The surface 30b opposes the surface 30a, to which the motor 96 is attached. Furthermore, the ECU 40 is attached to the surface 30b in a manner to surround the plural control valves.

The ECU 40 has a cover 41. An electric circuit that controls driving of the plural control valves and the motor 96 is provided in the cover 41. An external coupling connector 49 is also provided in a part of the cover 41.

The external coupling connector 49 is electrically coupled to the electric circuit and receives a drive instruction signal from a control system on the vehicle side.

The ECU 40 controls driving of each of the control valves. The plural control valves are inserted in valve accommodation holes provided in the surface 30b of the housing 30, and are accommodated in the ECU 40.

In addition, at least one pressure sensor, which is not illustrated and detects a pressure of the brake fluid at a specified position, is mounted on the surface 30b of the housing 30.

The pump element 44 is mounted on each of two mutually opposing surfaces 30c, 30d. Each of the two surfaces 30c, 30d continues perpendicularly from the surface 30a, to which the motor 96 is attached, and the surface 30b, to which the ECU 40 is attached.

Each of the pump elements 44 is assembled in a pump accommodation hole 31 provided in the housing 30. Each of the two pump elements 44 pressure-feeds the brake fluid in the respective hydraulic circuit. Each of the pump elements 44 is driven by rotation of a cam that is fixed to the motor shaft of the motor 96, and suctions and discharges the brake fluid when a piston thereof reciprocates along an orthogonal direction to an axis of the motor shaft.

The number of the pump element 44 provided in each of the hydraulic circuits is not limited to one. The plural pump elements 44 may be provided in each of the hydraulic circuits.

Four coupling ports 33a to 33d are provided in a surface 30e that continues perpendicularly from each of the surface 30a, to which the motor 96 is attached, the surface 30b, to which the ECU 40 is attached, and the surfaces 30c, 30d, on each of which the pump element 44 is mounted.

Fluid pipes are coupled to the four coupling ports 33a to 33d. The fluid pipes are also coupled to front-wheel master cylinder, a rear-wheel master cylinder, a front-wheel wheel cylinder, and a rear-wheel wheel cylinder, which are not illustrated.

An accumulator, which is not illustrated, is assembled to a surface 30f that continues perpendicularly from each of the surface 30a, to which the motor 96 is attached, the surface 30b, to which the ECU 40 is attached, and the surfaces 30c, 30d, on each of which the pump element 44 is mounted. The accumulator is assembled in an accumulator bore provided in the surface 30f of the housing 30.

A dimension of the housing 30 along an axial direction of the motor shaft of the motor 96 (a distance between the surface 30a and the surface 30b) is smaller than dimensions in the other two mutually orthogonal directions. In other words, in the brake hydraulic pressure controller 10 according to this embodiment, the motor 96 and the ECU 40 are respectively attached to the surfaces 30a, 30b at both ends of the housing 30 in a narrow width direction, and a position of center of gravity of the hydraulic unit 20 is set close to a center of the entire hydraulic unit 20.

The bracket 80 is a plate member formed in a U shape. A bottom section 80c of the U-shaped bracket 80 is arranged in a manner to oppose the surface 30f, to which the accumulator is assembled. The bottom section 80c of the bracket 80 is not in contact with the hydraulic unit 20 so as to prevent vibrations of the vehicle from being transmitted to the hydraulic unit 20.

In the U-shaped bracket 80, a first side section 80a and a second side section 80b, which oppose each other, are respectively arranged on the surface 30a side and the surface 30b side. The first side section 80a of the bracket 80 is arranged in a manner not to contact the motor 96, which is attached to the surface 30a.

The first side section 80a has two openings, which are not illustrated, on both sides in a width direction. A first support member 110 that supports the hydraulic unit 20 is attached to each of the openings. Only one of the first support members 110 is illustrated in FIG. 1 to FIG. 3. When each of these first support members 110 is fixed to the surface 30a of the housing 30, the hydraulic unit 20 is supported by the first side section 80a of the bracket 80.

FIG. 4 is a cross-sectional view of a configuration example of the first support member 110 that supports the hydraulic unit 20 in the first side section 80a. The first support member 110 includes a vibration absorbing member 111, a sleeve 113, and a fixing pin 115.

The vibration absorbing member 111 is made of elastic rubber, for example, and is mounted in an opening 80aa provided in the first side section 80a. The vibration absorbing member 111 has a hole 111a that penetrates in an axial direction. The sleeve 113 having a flange 113a is press-fitted into the hole 111a from one end side.

The fixing pin 115 is inserted in the sleeve 113 from the other end side, and a tip of the fixing pin 115 is fixed in the surface 30a of the housing 30. The tip of the fixing pin 115 may be screwed or press-fitted into the surface 30a. A flange 115a of the fixing pin 115 presses the vibration absorbing member 111 and the sleeve 113 against the surface 30a of the housing 30 and thereby fixes the vibration absorbing member 111 and the sleeve 113.

In this way, the vibration absorbing member 111 is interposed between the housing 30 and the bracket 80, and the hydraulic unit 20 is supported by the first side section 80a of the bracket 80 without directly contacting the bracket 80.

The second side section 80b has two openings 80ba on both sides in the width direction. The second support member 120 that supports the hydraulic unit 20 is attached to each of the openings 80ba. When each of these second support members 120 is fixed to the surface 30b of the housing 30, the hydraulic unit 20 is supported by the second side section 80b of the bracket 80.

Each of the second support members 120 has a function of fixing the ECU 40 to the housing 30. That is, each of the second support members 120 has a function of supporting the hydraulic unit 20 on the second side section 80b of the bracket 80 and the function of fixing the ECU 40 to the housing 30.

The ECU 40 is fixed to the housing 30 by a fixing screw 130 in addition to the second support members 120.

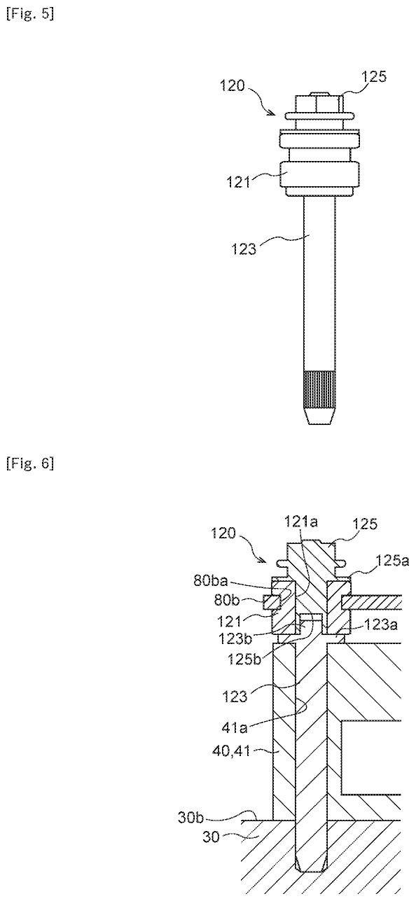

FIG. 5 and FIG. 6 are explanatory views of a configuration example of the second support member 120 that supports the hydraulic unit 20 in the second side section 80b. FIG. 5 is a view of external appearance of the second support member 120, and FIG. 6 is a cross-sectional view of the second support member 120.

The second support member 120 includes a vibration absorbing member 121, a pin 123, and a pin head 125.

The vibration absorbing member 121 is made of the elastic rubber, for example, and is mounted in the opening 80ba provided in the second side section 80b. The vibration absorbing member 121 has a hole 121a that penetrates in an axial direction. The pin head 125 having a flange 125a is press-fitted into the hole 121a from one end side.

The pin head 125 has a recess 125b in a tip surface. A fitted projection 123b of the pin 123 having a flange 123a is press-fitted into this recess 125b, and the pin 123 and the pin head 125 are thereby fixed to each other. In this way, the vibration absorbing member 121 is held between the flange 123a of the pin 123 and the flange 125a of the pin head 125.

The pin 123 is inserted in a pin insertion hole 41a provided in the cover 41 of the ECU 40, and a tip of the pin 123 is fixed in the surface 30b of the housing 30. The tip of the pin 123 may be screwed or press-fitted into the surface 30b. The flange 123a of the pin 123 presses the ECU 40 against the surface 30b of the housing 30 and thereby fixes the ECU 40.

In this way, the vibration absorbing member 121 is interposed between the ECU 40 and the bracket 80, and the hydraulic unit 20 is supported by the second side section 80b of the bracket 80 without directly contacting the bracket 80.

In the brake hydraulic pressure controller 10 according to this embodiment, length of the second side section 80b of the bracket 80 is longer than length of the first side section 80a of the bracket 80. A fixed position of each of the first support members 110 is located on the surface 30f side, to which the accumulator is assembled, and a fixed position of each of the second support members 120 is located on the surface 30e side, in which the coupling ports 33a to 33d are provided.

Thus, the hydraulic unit 20 is supported by the bracket 80 in a manner to be held between the bracket 80. As a result, the hydraulic unit 20 is stably supported by the bracket 80. Therefore, an effect of suppressing vibrations of the hydraulic unit 20 can be improved.

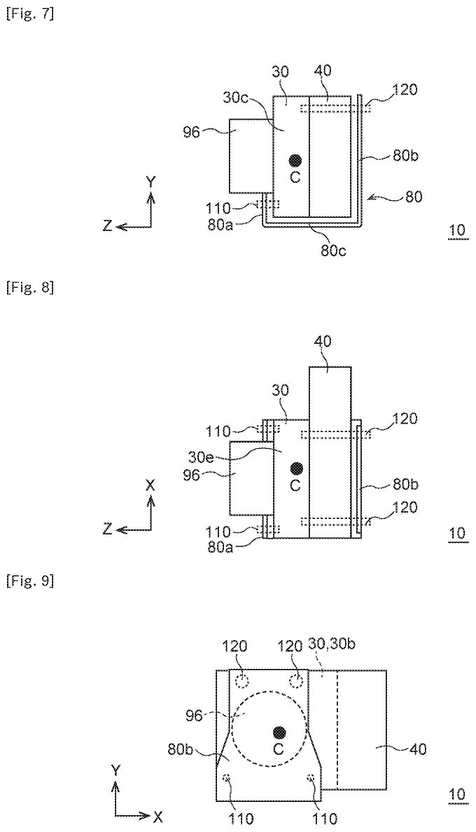

FIG. 7 to FIG. 9 are explanatory views of a relationship between a position of center of gravity C of the hydraulic unit 20 and the fixed position of each of the first support member 110 and the second support member 120.

FIG. 7 is a schematic view of the brake hydraulic pressure controller 10 that is seen from the surface 30c side, on which the pump element 44 is mounted. FIG. 8 is a schematic view of the brake hydraulic pressure controller 10 that is seen from the surface 30e side, in which the coupling ports 33a to 33d are formed. FIG. 9 is a schematic view of the brake hydraulic pressure controller 10 that is seen from the surface 30b side, to which the ECU 40 is attached.

In the brake hydraulic pressure controller 10 according to this embodiment, the first support members 110 and the second support members 120 are fixed to the housing 30 in a manner to hold the center of gravity C of the hydraulic unit 20 therebetween. Thus, the hydraulic unit 20 is further stably supported by the bracket 80, and the effect of suppressing the vibrations of the hydraulic unit 20 can further be improved.

As it has been described so far, in the brake hydraulic pressure controller 10 according to this embodiment, the first support members 110 and the second support members 120, which support the hydraulic unit 20 on the bracket 80 via the vibration absorbing members 111, 121, are respectively coupled to the mutually opposing surfaces 30a, 30b of the housing 30 for the hydraulic unit 20.

Thus, the hydraulic unit 20 can stably be supported by the bracket 80. In this way, the effect of suppressing the vibrations of the hydraulic unit 20 can be improved.

In addition, in the brake hydraulic pressure controller 10 according to this embodiment, the fixed positions of the first support members 110 and the fixed positions of the second support members 120 to the housing 30 are arranged in the manner to hold the center of gravity C of the hydraulic unit 20 therebetween.

Thus, the hydraulic unit 20 can further stably be supported by the bracket 80, and the effect of suppressing the vibrations of the hydraulic unit 20 can further be improved.

Furthermore, in the brake hydraulic pressure controller 10 according to this embodiment, the ECU 40 is arranged on the surface 30b, to which the second support members 120 are coupled, and the ECU 40 is fixed to the housing 30 by the second support members 120.

That is, each of the second support members 120 has the function of fixing the ECU 40. Therefore, the number of components can be reduced, and manufacturing cost can be reduced.

In addition, each of the second support members 120 has the function of fixing the ECU 40. Thus, compared to the case where a screw or the like is provided to fix the ECU 40 in addition to the second support members 120, an arrangement space of the screw or the like is unnecessary, and the controller can be downsized.

The preferred embodiment of the present invention has been described in detail so far with reference to the accompanying drawings. However, the present invention is not limited to such an embodiment. It is obvious that a person who has basic knowledge in the technical field to which the present invention pertains could have easily arrived at various modification examples and application examples that fall within the scope of the technical idea described in the claims. It is understood that those naturally fall within the technical scope of the present invention.

For example, the configuration of each of the first support member 110 and the second support member 120 described in the above embodiment merely constitutes one example. The configuration of each of the first support member 110 and the second support member 120 can appropriately be changed.

In the above embodiment, the description has been made on the brake hydraulic pressure controller that is mounted on the four-wheel drive vehicle as the example. However, the present invention is not limited to such an example. The brake hydraulic pressure controller may be mounted on another vehicle such as a motorcycle.

### REFERENCE SIGNS LIST

10: Brake hydraulic pressure controller
20: Hydraulic unit
30: Housing
30a, 30b: (Opposing) surface
40: ECU
80: Bracket
80a: First side section
80b: Second side section
80c: Bottom section
110: First support member
111: Vibration absorbing member
120: Second support member
121: Vibration absorbing member

1. A brake hydraulic pressure controller (10) including:
a hydraulic unit (20) configured to execute brake control by controlling a hydraulic pressure of a brake fluid;
a bracket (80) configured to be attached to a vehicle body to support the hydraulic unit (20); and
first and second support members (110, 120) that are assembled in openings (80aa, 80ba) provided in the bracket (80) and that are coupled to the hydraulic unit (20),
wherein the support members (110, 120) are coupled to two mutually opposing surfaces (30a, 30b) of a housing (30) of the hydraulic unit (20).

2. The brake hydraulic pressure controller according to claim 1, wherein
the support members (110, 120) have vibration absorbing members (111, 121) that are arranged in the openings (80aa, 80ba) of the bracket (80).

3. The brake hydraulic pressure controller according to claim 1, wherein
an electronic control unit (40) is arranged on at least one surface (30b) of the two surfaces (30a, 30b), and
the electronic control unit (40) is fixed to the housing (30) by the second support member (120).

4. The brake hydraulic pressure controller according to claim 3, wherein
the second support member (120) has:
a vibration absorbing member (121) arranged in one of the openings (80ba) of the bracket (80); and
a pin (123) inserted in the electronic control unit (40).

5. The brake hydraulic pressure controller according to claim 2, wherein
the vibration absorbing members (111, 121) of the support members (110, 120) are located on both sides of a center of gravity of the brake hydraulic pressure controller (10).

6. The brake hydraulic pressure controller according to claim 1, wherein
the bracket (80) is in a U shape having:
a first side section (80a) and a second side section (80b) arranged on sides of the two surfaces (30a, 30b) of the housing (30); and
a bottom section (80c) that continues to the first side section (80a) and the second side section (80b).

7. The brake hydraulic pressure controller according to claim 2, wherein
an electronic control unit (40) is arranged on at least one surface (30b) of the two surfaces (30a, 30b), and
the electronic control unit (40) is fixed to the housing (30) by the second support member (120).

8. The brake hydraulic pressure controller according to claim 7, wherein
the second support member (120) has:
one of the vibration absorbing members (121) arranged in one of the openings (80ba) of the bracket (80); and
a pin (123) inserted in the electronic control unit (40).

9. The brake hydraulic pressure controller according to claim 8, wherein
the vibration absorbing members (111, 121) of the support members (110, 120) are located on both sides of a center of gravity of the brake hydraulic pressure controller (10).

10. The brake hydraulic pressure controller according to claim 9, wherein
the bracket (80) is in a U shape having:
a first side section (80a) and a second side section (80b) arranged on sides of the two surfaces (30a, 30b) of the housing (30); and
a bottom section (80c) that continues to the first side section (80a) and the second side section (80b).
